(19) United States
(12) Patent Application Publication
(10) Pub. No.: US 2025/0306960 A1
(43) Pub. Date: Oct. 2, 2025

(54) METHOD, SYSTEM, AND NON-TRANSITORY COMPUTER-READABLE RECORDING MEDIUM FOR PREVENTING OVERHEATING

(71) Applicant: CINCOZE CO., LTD., New Taipei City (TW)

(72) Inventor: HSIN-TE CHIEN, New Taipei City (TW)

(73) Assignee: CINCOZE CO., LTD., New Taipei City (TW)

(21) Appl. No.: 18/736,582

(22) Filed: Jun. 7, 2024

(30) Foreign Application Priority Data
Apr. 2, 2024 (TW) 113112557

(51) Int. Cl. G06F 9/448

(52) U.S. Cl. CPC G06F 9/448

(57) ABSTRACT

A method for preventing overheating. The method is adapted to be performed by a computer device. The method includes: detecting a system operating state, restarting the computing device when the system operating state is an overheat preventing state, detecting the system operating state again after the computing device is restarted, and restarting the computing device and adjusting an operating efficiency of the computing device to a low-efficiency mode when the system operating state is still in the overheat preventing state. The detecting of the system operating state includes: receiving heat dissipation device operation information, comparing the heat dissipation device operation information with an operation basis value and generating an operation comparison result, and determining the system operating state according to the operation comparison result.

### CROSS-REFERENCE TO RELATED APPLICATION

This non-provisional application claims priority under 35 U.S.C. § 119(a) on Patent Application No(s). 113112557 filed in Taiwan, R.O.C. on Apr. 2, 2024, the entire contents of which are hereby incorporated by reference.

### BACKGROUND OF THE INVENTION

### 1. Field of the Invention

The present disclosure relates to a protection method, system, and recording medium, and in particular to a method, a system, and a non-transitory computer-readable recording medium for preventing overheating.

### 2. Description of the Related Art

A processing module such as a central processing unit (CPU) or a graphics processing unit (GPU) is a core computing element of a computer device. Since these core computing elements themselves are a type of integrated circuit, in a way that these core computing elements inevitably generate a certain amount of heat when powered for operation. More specifically, along with the increasing computing amount that needs to be performed by computer devices, these core computing elements also generate more heat in response to the increase in the computing requirements.

The heat generated by these core computing elements easily leads to overheating of computer devices, further affecting the performance and service life of the computer devices. Conventionally, in order to prevent these core computing elements from imposing negative influences caused by overheating on internal elements of the computer devices, a user or a product developer often needs to prevent overheating of the computer devices by initiatively using means such as metal heatsinks having a greater thermal conductivity, a thermal paste, or other heat dissipation devices (for example, fans).

Moreover, some central processing units (for example, central processing units manufactured by Intel Corporation) themselves are designed to have a frequency reduction protection mechanism against high temperatures, such that these central processing units can gradually reduce operating efficiencies of these central processing units as the operating temperature goes beyond a safety range (For example, a predetermined value or a user-defined basis value with respect to the ambient environment), thereby preventing overheating of the computer devices.

### BRIEF SUMMARY OF THE INVENTION

Although conventional techniques are intended for preventing overheating of computer devices, these conventional techniques nonetheless suffer their own drawbacks. Taking a central processing unit having a frequency reduction protection mechanism against high temperatures for example, these central processing units often take an extremely long period of time to implement the process of frequency reduction in response to high temperatures, such that the conventional computer devices unavoidably remain in a high-temperature state for a certain period of time before these central processing units complete the frequency reduction operation in response to high temperatures and the heat previously generated is fully dissipated. In addition, taking a fan for another example, when the fan malfunctions or when a rotating speed of the fan decreases, a conventional computer device does not take an additional countermeasure, such that the conventional computer device remains in an overheating state because the fan is unable to fully practice its function, further affecting the performance and service life of the computer device.

Moreover, in terms of practical operations, a user in fact does not constantly pay attention to the rotating speed of a fan and/or an operating temperature of a central processing unit during the operation of a computer device. Thus, it is frequent that the user further evaluates, only when the computer device is in the overheating state, whether a heat dissipation means of the computer device needs to be checked and/or adjusted (for example, replacement for a new fan) in order to prevent the computer device from becoming overheated again. However, the heat generated by these core computing elements has already undesirably affected the performance and service life of the computer device.

Therefore, it is imperative to come up with a solution for overcoming the issues of the prior art and to initiatively and effectively prevent overheating of computer devices for the present technical field.

To overcome the issues above, the present disclosure provides a method for preventing overheating. The method is adapted to be performed by a computer device. The method for preventing overheating includes: detecting a system operating state, restarting the computer device when the system operating state is in an overheat preventing state, detecting the system operating state again after the computer device is restarted, and restarting the computer device and adjusting an operating efficiency of the computer device to a low-efficiency mode when the system operating state is still in the overheat preventing state. The detecting of the system operating state includes: receiving heat dissipation device operation information, comparing the heat dissipation device operation information with an operation basis value and generating an operation comparison result, and determining the system operating state according to the operation comparison result.

In some embodiments, the low-efficiency mode is an operation mode of setting the computer device to be operable with a highest operation efficiency without a heat dissipation device.

In some embodiments, the step of determining the system operating state according to the operation comparison result includes: when the operation comparison result indicates that the heat dissipation device operation information is less than the operation basis value within a range of a predetermined time value, determining that the system operating state is in the overheat preventing state.

In some embodiments, the heat dissipation device operation information is a fan rotating speed value, and the operation basis value is 800 revolutions per minute (RPM).

In some embodiments, the step of detecting the system operating state further includes: receiving operating temperature information of the computer device; when the operation comparison result indicates that the heat dissipation operation information is less than the operation basis value, comparing the operating temperature information with an operating temperature basis value and generating an operating temperature comparison result; and when the operation comparison result indicates that the heat dissipation device operation information is less than the operation basis value, the system operating state is further determined according to the operating temperature comparison result.

In some embodiments, the step of determining the system operating state according to the operation comparison result includes: when the operation comparison result indicates that the heat dissipation device operation information is less than the operation basis value within a range of a predetermined time value, and the operating temperature comparison result indicates that the operating temperature information is greater than or equal to the operating temperature basis value within the range of the predetermined time value, determining that the system operating state is in the overheat preventing state.

In some embodiments, the method for preventing overheating is activated according to a user selection result.

Additionally, the present disclosure further provides a system for preventing overheating. The system includes a heat dissipation device and a computer device. The heat dissipation device is configured to provide heat dissipation device operation information. The computer device is configured to be coupled to the heat dissipation device. The computer device includes a storage module and a processing module. The storage module is configured to have a computer program product stored therein. The processing module is configured to be coupled to the storage module. After the processing module loads and executes the computer program product, the processing module is capable of performing any one of the methods for preventing overheating described in the present disclosure.

In some embodiments, the processing module is further capable of determining whether to activate the method for preventing overheating according to a user selection result.

Additionally, the present disclosure further provides a non-transitory computer-readable recording medium for preventing overheating. After a computer device loads and executes a computer program product stored in the non-transitory computer-readable recording medium, the computer device is capable of performing any one of the methods for preventing overheating described in the present disclosure.

Thus, beneficial effects that could not be achieved by the prior art can be achieved by the technical means provided by the present disclosure. More specifically, the beneficial effects achieved by the present disclosure can initiatively and effectively prevent overheating of a computer device, thereby ensuring the performance of the computer device and protecting the service life of the computer device.

### BRIEF DESCRIPTION OF THE DRAWINGS

FIG. 1 is a block schematic diagram of a system for preventing overheating according to an embodiment of the present disclosure.

FIG. 2 is a flowchart of a method for preventing overheating according to an embodiment of the present disclosure.

FIG. 3 is a detailed flowchart for detecting a system operating state according to an embodiment of the present disclosure.

FIG. 4 is a detailed flowchart for detecting a system operating state according to another embodiment of the present disclosure.

### DETAILED DESCRIPTION OF THE INVENTION

In the following description of the present disclosure, details of the present disclosure are provided by way of the embodiments with reference to the accompanying drawings, so as to help a person skilled in the technical field pertinent to the present disclosure to better understand the objects, features and effects of the present disclosure.

It should be noted that, the various steps described in the present disclosure can be performed sequentially, in reverse order, or by appropriately changing or skipping a step in the order during a control process. It should be noted that, the expression “a first step can be performed subsequent to a second step” described in the present disclosure can be interpreted that the first step follows after the second step is completely performed, or can interpreted that another step (for example, a third step) follows after the second step is completely performed and the first step follows subsequently.

Moreover, in the description of the present disclosure, it should be noted that the terms such as “first”, “second”, and “third” are used to distinguish differences among elements, and are not to be construed as limitations to the elements themselves and specific sequence of the elements. It should be noted that, in the description below, the same elements or steps can be denoted with the same symbols or numerals.

Moreover, the term “coupled” in the present disclosure can be interpreted as “directly connected” and/or “indirectly connected”. More specifically, “a first element configured to be coupled to a second element” can be interpreted as “a first element configured to be directly connected to a second element” and/or “a first element configured to be indirectly connected to a second element”.

It should be noted that, the expression “an overheat preventing state” described in the present disclosure can be a system operating state, that is, “an operating state of preventing a high temperature of a computer device”. In some embodiments, the high temperature can refer to a temperature exceeding an operating temperature value (for example, 50° C. to 60° C.) of a computer device. In some other embodiments, the high temperature can also refer to a temperature exceeding an expected temperature value (for example, 30° C. to 80° C.) of the application.

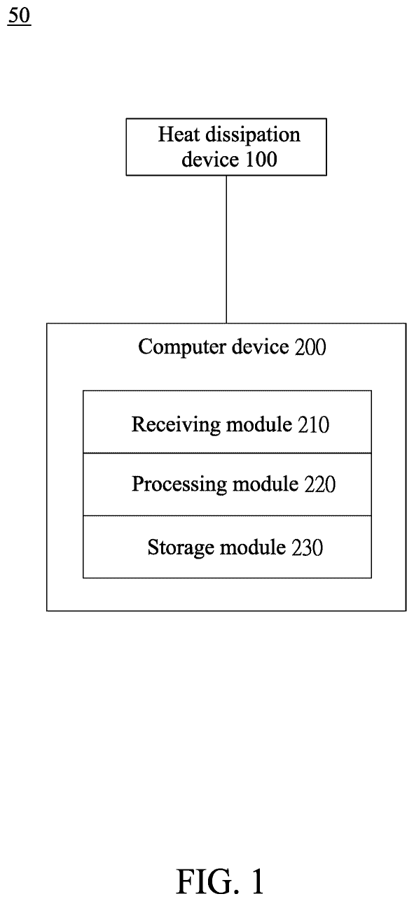

Referring to FIG. 1, FIG. 1 shows a block schematic diagram of a system 50 for preventing overheating according to an embodiment of the present disclosure. The system 50 for preventing overheating includes a heat dissipation device 100 and a computer device 200, wherein the computer device 200 is configured to be coupled to the heat dissipation device 100. Since the computer device 200 is coupled to the heat dissipation device 100, the computer device 200 can power the heat dissipation device 100 via a physical line, such that the heat dissipation device 100 can dissipate heat generated during operation of the computer device 200. Additionally, the computer device 200 can also receive operation-related information of the heat dissipation device 100 from the heat dissipation device 100 via the physical line. In some embodiments, in order to enhance ease of installation and/or removal, the physical line of the heat dissipation device 100 can be integrated with a physical connector. Thus, a user can couple the heat dissipation device 100 to the computer device 200 by plugging the physical connector onto a motherboard.

In some embodiments, the heat dissipation device 100 can be a 3-pin fan or a 4-pin fan generally known to a person of ordinary skill in the technical field pertinent to the present disclosure. Taking a 3-pin fan for example, the heat dissipation device 100 has a power line, a ground line, and a signal line, and the power line, the ground line and the signal line can be integrated into one physical connector. Moreover, taking a 4-pin fan for example, the heat dissipation device 100 has a power line, a ground line, a signal line, and a pulse width modulation (PWM) line, and the power line, the ground line, the signal line, and the PWM line can be integrated into one physical connector. When the heat dissipation device 100 is coupled to the computer device 200, the computer device 200 powers the heat dissipation device 100 via the power line and the ground line. In some embodiments, a voltage supplied by the computer device 200 can be, for example, a voltage of 12V. Additionally, when the heat dissipation device 100 is coupled to the computer device 200, the computer device 200 receives the operation-related information of the heat dissipation device 100 from the heat dissipation device 100 via the signal line. In some embodiments, the operation-related information of the heat dissipation device 100 can be, for example, whether the heat dissipation device 100 rotates normally during a powered period or a rotating speed during a powered period. In a specific example, the rotating speed of the heat dissipation device 100 during a powered period can be represented by revolutions per minute (RPM). For example, when the rotating speed of the heat dissipation device 100 during a powered period is 1000 revolutions per minute, it can be represented as 1000 RPM.

In some embodiments, the computer device 200 can include a receiving module 210, a processing module 220, and a storage module 230. Thus, the computer device 200 can execute a computer program product stored in the storage module 230 by the processing module 220, further performing the various steps of a method for preventing overheating described in the present disclosure, thereby initiatively and effectively preventing overheating of the computer device 200 in accordance with information received by the receiving module 210 to accordingly ensure the performance of the computer device 200 and protect the service life of the computer device 200.

Since the heat dissipation device 100 is coupled to the computer device 200, the receiving module 210 can be configured to receive the operation-related information of the heat dissipation device 100 from the heat dissipation device 100. In a specific example, the operation-related information of the heat dissipation device 100 can be the rotating speed of the heat dissipation device 100 during a powered period, that is, a fan rotating speed value described in the present disclosure.

The storage module 230 can be configured to have a computer program product stored therein, wherein the computer program product can be a line or multiple lines of program codes and/or instruction sets. More specifically, the storage module 230 can be further configured to have a predetermined computer program product stored therein, for the processing module 220 to perform predetermined steps after loading and executing the computer program product, further implementing any one of the methods for preventing overheating described in the present disclosure.

In some embodiments, the storage module 230 can include one or more non-volatile memories or one or more volatile memories. In some embodiments, the volatile memory can be a product generally known to a person skilled in the technical field pertinent to the present disclosure, for example but not limited to, various types of dynamic random access memories (DRAM) or static random access memories (SRAM). In some embodiments, the non-volatile memory can be a product generally known to a person skilled in the technical field pertinent to the present disclosure, for example but not limited to, various types of read-only memories (ROM) or flash memories. In some embodiments, the computer program product can be stored in the non-volatile memory (for example, a ROM).

The processing module 220 can be configured to be coupled to the storage module 230, for the processing module 220 to load and execute the computer program product stored in the storage module 230 to further perform predetermined steps. Additionally, the processing module 220 can be configured to be coupled to the receiving module 210, for the processing module 220 to receive the operation-related information (for example, a fan rotating speed) of the heat dissipation device 100 and further perform corresponding steps according to the operation-related information of the heat dissipation device 100. In some embodiments, the processing module 220 can be a product generally known to a person skilled in the technical field pertinent to the present disclosure, for example but not limited to, various types of central processing units (CPU) or graphics processing units (GPU).

In some embodiments, a heat dissipation effect of the heat dissipation device 100 can be affected by factors such as vibrations or impact, its service life, dust or stains, manual installation, or other ambient environmental factors (for example, high temperatures, humidity, salty spray, or chemical corrosion). Taking vibrations or impact for example, when the heat dissipation device 100 encounters sudden vibration or impact, the structure of the heat dissipation device 100 can be damaged or loosened (for example, a bearing of a motor in the heat dissipation device 100 can become deviated), further affecting the heat dissipation effect of the heat dissipation device 100. Taking the service life of the heat dissipation device 100 for example, as the time elapses, the mechanical structure of the heat dissipation device 100 is inevitably subject to wear (for example, aging of the motor) due to usage over an extended period of time, further affecting the heat dissipation effect of the heat dissipation device 100. In view of the above, when the heat dissipation effect of the heat dissipation device 100 is affected, since the storage module 230 has the computer program product (that is, predetermined program codes and/or instruction sets) stored therein, the processing module 220 can timely, initiatively, and effectively perform corresponding steps ahead of time according to the operation-related information (that is, the fan rotating speed value) of the heat dissipation device 100, thereby preventing overheating of the computer device 200 to accordingly ensure the performance of the computer device 200 and protect the service life of the computer device 200.

In some embodiments, the processing module 220 can further determine whether to activate the method for preventing overheating according to a user selection result. More specifically, the method for preventing overheating can be packaged into a function block option for a user to select whether to use the method for preventing overheating (that is, determining whether the processing module 220 is to perform the various steps of the method for preventing overheating). In a specific example, the user can selectively check this function block option in an operating interface of a basic input/output system (BIOS), so as to determine whether the processing module 220 is to further perform the method for preventing overheating. Thus, the user is provided with operation flexibilities by the setting of the function block option, thereby enabling the computer device 200 to meet operation requirements for the user. In some embodiments, a default value of the user selection result can be an activated state.

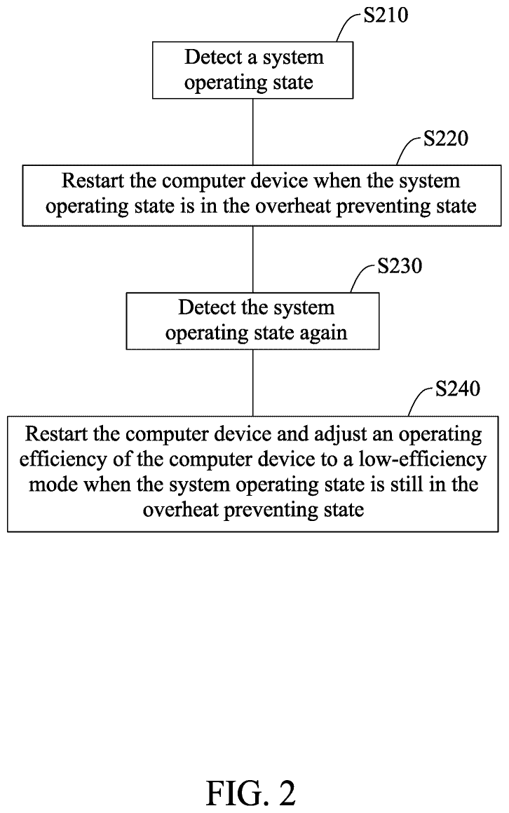

Referring to FIG. 2, FIG. 2 shows a flowchart of a method for preventing overheating according to an embodiment of the present disclosure. The method for preventing overheating in FIG. 2 can be performed by the processing module 220 shown in FIG. 1, so as to initiatively and effectively prevent overheating of the computer device 200. The method shown in FIG. 2 can include steps S210, S220, S230, and S240.

In step S210, a system operating state is detected. More specifically, since the receiving module 210 can receive, such as heat dissipation device operation information or operating temperature information of the computer device 200, the processing module 220 can evaluate an operating condition of the heat dissipation device 100 and/or an operating condition of the computer device 200 according to the information received to evaluate a usage condition of the system 50 for preventing overheating, further detecting a system operating state associated with the system 50 for preventing overheating. In some embodiments, the system operating state can include a normal state and an overheat preventing state.

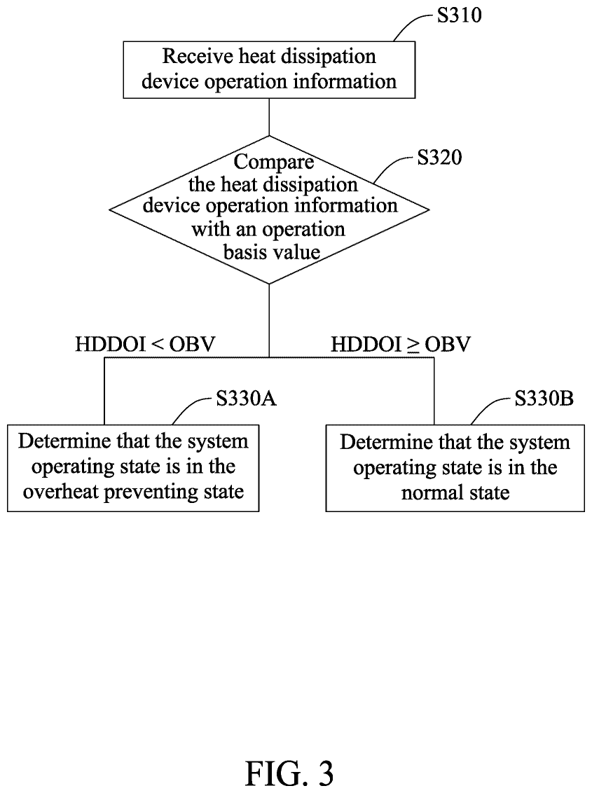

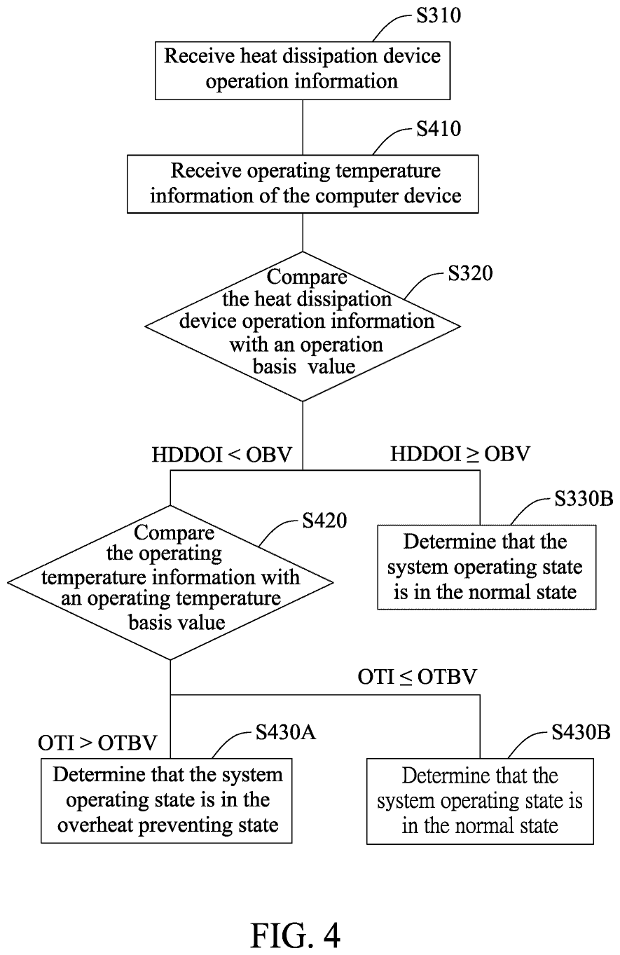

In a specific example, the system operating state can be determined according to whether the heat dissipation device 100 is in operation. More specifically, when the heat dissipation device operation information indicates that the heat dissipation device 100 is currently in operation, the system operating state is determined as the normal state; conversely, when the heat dissipation device operation information indicates that the heat dissipation device 100 is not in operation, the system operating state is determined as the overheat preventing state. Additionally, the system operating state can also be determined according to the fan rotating speed value of the heat dissipation device 100, with associated details depicted in FIG. 3. Additionally, the system operating state can be further determined according to the fan rotating speed value of the heat dissipation device 100 and an operating temperature of the computer device 200, with associated details depicted in FIG. 4.

In step S220, when the system operating state is in the overheat preventing state, the computer device 200 is restarted. More specifically, when the processing module 220 detects that the system operating state is in the overheat preventing state, the processing module 220 further sends a restart command to thereby restart the computer device 200. In some embodiments, step S220 can be performed subsequent to step S210. More specifically, when the processing module 220 detects that the system operating state is in the normal state, the processing module 220 does not send any additional command to thereby allow a user to continue using the computer device 200.

In step S230, the system operating state is detected again. More specifically, the processing module 220 detects the system operating state again after the computer device 200 is restarted. In some embodiments, step S230 can be performed subsequent to step S220. In some embodiments, details performed in step S230 and those in step S210 can be substantially the same, that is, the detecting of the system operating state again performed in step S230 can also be the same as the various steps shown in FIG. 3 or FIG. 4. It is possible that the computer device 200 during operation can accidentally cause malfunctions of the heat dissipation device 100, and it is possible that these malfunctions in practice are resolved after the computer device 200 is restarted. Thus, by performing step S230, the processing module 220 can more carefully confirm whether the system operating state is indeed in the overheat preventing state (that is, the processing module 220 detects again whether the system operating state is still in the overheat preventing state after the computer device 200 is recovered to the setting of the default value).

In step S240, when the system operating state is still in the overheat preventing state, the computer device 200 is restarted, and an operating efficiency of the computer device 200 is adjusted to a low-efficiency mode. More specifically, when the processing module 220 detects that the system operating state is in the overheat preventing state, the processing module 220 further sends a restart command, and further adjusts the operating efficiency of the processing module 220 in the computer device 200 to a low-efficiency mode. In some embodiments, step S240 can be performed subsequent to step S230. More specifically, when the processing module 220 detects that the system operating state is in the normal state, the processing module 220 does not send any additional command to thereby allow the user to continue using the computer device 200.

Taking an i7-13700 CPU for example, when the processing module 220 detects that the system operating state is in the normal state, the processing module 220 can adjust an operating frequency of the processing module 220 according to a computation amount that needs to be executed, such that the processing module 220 can compute at an operating frequency ranging between 1.1 GHz and 4.8 GHz. When the processing module 220 detects that the system operating state is still in the overheat preventing state, the processing module 220 further sends a restart command, and further adjusts the operating efficiency of the processing module 220 in the computer device 200 to the low-efficiency mode, for example, fixing the operating frequency of the processing module 220 to a lowest operating frequency (that is, 1.1 GHz).

Additionally, after the operating efficiency of the processing module 220 is adjusted to the low-efficiency mode, the processing module 220 can continuously detect the system operating state. Once the processing module 220 detects that the system operating state has recovered to the normal state, the processing module 220 further sends a restart command, and the processing module 220 is further recovered to the normal operating mode.

In some embodiments, the low-efficiency mode is an operation mode of setting the computer device 200 to be operable with a highest operation efficiency without the presence of the heat dissipation device 100, thereby attending to both the operating efficiency of the computer device 200 and the service life of the computer device 200.

Thus, with the method for preventing overheating shown in FIG. 2, the heat dissipation device operation information and/or the operating temperature information of the computer device 200 can be appropriately utilized to further detect the system operating state, and corresponding steps with respect to the system operating state in the overheat preventing state can be timely, initiatively, and effectively performed ahead of time, thereby preventing overheating of the computer device 200 to accordingly ensure the performance of the computer device 200 and protect the service life of the computer device 200.

In some embodiments, when the processing module 220 detects that the system operating state is in the normal state, the processing module 220 can return to step S210 to further iterate the method for preventing overheating described in the present disclosure, thereby constantly preventing overheating of the computer device 200 to accordingly ensure the performance of the computer device 200 and continuously protect the service life of the computer device 200.

Referring to FIG. 3, FIG. 3 shows a detailed flowchart for detecting a system operating state according to an embodiment of the present disclosure. That is to say, the steps for detecting the system operating state (that is, step S210 and/or step S230) shown in FIG. 2 can be completed by steps S310, S320, S330A and S330B shown in FIG. 3.

In step S310, heat dissipation device operation information HDDOI is received. More specifically, since the heat dissipation device 100 is coupled to the computer device 200, the receiving module 210 can receive the operation-related information of the heat dissipation device 100 (that is, the heat dissipation device operation information HDDOI) from the heat dissipation device 100. In a specific example, the heat dissipation device operation information HDDOI can be the rotating speed of the heat dissipation device 100 during a powered period, that is, the fan rotating speed value described in the present disclosure. In some embodiments, the computer device 200 can continuously receive the heat dissipation device operation information HDDOI.

In step S320, the heat dissipation device operation information HDDOI is compared with an operation basis value OBV. More specifically, after the receiving module 210 receives the heat dissipation device operation information HDDOI, the processing module 220 compares the received heat dissipation device operation information HDDOI with the operation basis value OBV, and generates an operation comparison result. The operation comparison result can indicate, for example, that the heat dissipation device operation information HDDOI is greater than or equal to the operation basis value OBV and that the heat dissipation device operation information HDDOI is less than the operation basis value OBV. In some embodiments, step S320 can be performed subsequent to step S310.

In some embodiments, the operation basis value OBV can be a default value (for example, 800 RPM or 1000 RPM), or a user-defined parameter value. When the operation basis value OBV is set as 800 RPM, the processing module 220 can further more carefully confirm whether the system operating state is indeed in the overheat preventing state, thereby preventing the computer device 200 from too frequently performing the corresponding step (that is, restarting the computer device 200) to accordingly attend to both normal use for the user and the service life of the computer device 200. Additionally, determining the operation basis value OBV by a user-defined parameter value can enhance operation flexibilities for the user.

When the operation comparison result indicates that the heat dissipation device operation information HDDOI is greater than or equal to the operation basis value OBV, it is determined that the system operating state is in the normal state (that is, step S330B is performed subsequently); when the operation comparison result indicates that the heat dissipation device operation information HDDOI is less than the operation basis value OBV, it is determined that the system operating state is in the overheat preventing state (that is, step S330A is performed subsequently).

In some embodiments, the processing module 220 can record the system operating state by means of providing a flag bit. For example, the processing module 220 can set the flag bit to a high logic level (that is, “H” or “1”) according to the operation comparison result, so as to record that the system operating state is in the overheat preventing state; alternatively, the processing module 220 can set the flag bit to a low logic level (that is, “L” or “0”) according to the operation comparison result, so as to record that the system operating state is in the normal state.

Thus, with the method shown in FIG. 3, the existing heat dissipation device operation information HDDOI can be appropriately utilized to detect the system operating state, for the processing module 220 to timely, initiatively, and effectively perform the corresponding steps ahead of time.

In some embodiments, only when the operation comparison result indicates that the heat dissipation device operation information HDDOI is less than the operation basis value OBV within a range of a predetermined time value, the processing module 220 then further determines that the system operating state is in the overheat preventing state. In some embodiments, the predetermined time value can be a default value (for example, 10 minutes) or a user-defined parameter value. When the predetermined time value is set as 10 minutes, the processing module 220 can further more carefully confirm whether the system operating state is indeed in the overheat preventing state, thereby preventing the computer device 200 from too frequently performing the corresponding step (that is, restarting the computer device 200) to accordingly attend to both normal use for the user and the service life of the computer device 200. Additionally, determining the predetermined time value by a user-defined parameter value can enhance operation flexibilities for the user.

Taking the predetermined time value as 10 minutes for example, the processing module 220 can perform step S320 in a unit of one minute to thereby generate the operation comparison result of each time. Next, each time when the operation comparison result indicates that the heat dissipation device operation information HDDOI is less than the operation basis value OBV, the processing module 220 counts a variable; each time when the operation comparison result indicates that the heat dissipation device operation information HDDOI is greater than or equal to the operation basis value OBV, the processing module 220 resets the variable to 0. That is to say, when a count result of the variable is 10, the processing module 220 subsequently performs step S330A (that is, determining that the system operating state is in the overheat preventing state).

In some embodiments, the computer device 200 can be further configured to be coupled to multiple heat dissipation devices 100. In this case, the receiving module 210 can receive operation-related information (that is, the heat dissipation device operation information HDDOI) of each of the heat dissipation devices 100 from the individual heat dissipation devices 100, and the processing module 220 can compare the individual heat dissipation device operation information HDDOI with the operation basis value OBV and generate the individual operation comparison results. Next, the processing module 220 can determine whether to subsequently perform step S330A or step S330B according to a distribution of these operation comparison results. For example, when a ratio of the heat dissipation device operation information HDDOI greater than or equal to the operation basis value OBV is a half or more (that is, greater than or equal to 50%), the processing module 220 can subsequently perform step S330B (that is, determining that the system operating state is in the normal state). When the ratio of the heat dissipation device operation information HDDOI is less than the operation basis value OBV is a half or more (that is, greater than or equal to 50%), the processing module 220 can subsequently perform step S330A (that is, determining that the system operating state is in the overheat preventing state).

Referring to FIG. 4, FIG. 4 shows a detailed flowchart for detecting a system operating state according to an embodiment of the present disclosure. That is to say, the steps for detecting the system operating state (that is, step S210 and/or step S230) shown in FIG. 2 can be completed by steps S310, S320, S330B, S410, S420, S430A and S430B shown in FIG. 4. The specific details of steps S310, S320 and S330B are substantially the same as those described above, and are thus omitted herein.

In step S410, operating temperature information OTI of the computer device 200 is received. More specifically, since the computer device 200 itself can learn the operating temperature information OTI of the computer device 200 by means of a thermistor sensor, a temperature-controlled diode, or a temperature sensor, the receiving module 210 can receive the operating temperature information OTI of the computer device 200 during a powered period. In some embodiments, the computer device 200 can continuously receive the operating temperature information OTI of the computer device 200.

Taking FIG. 4 for example, the processing module 220 first performs step S320 and then determines a step to be subsequently performed according to the operation comparison result. That is to say, only when the operation comparison result indicates that the heat dissipation device operation information HDDOI is less than the operation basis value OBV, the processing module 220 subsequently performs step S420.

In step S420, the operating temperature information OTI is compared with an operating temperature basis value OTBV. More specifically, after the receiving module 210 receives the operating temperature information OTI, when the operation comparison result indicates that the heat dissipation device operation information HDDOI is less than the operation basis value OBV, the processing module 220 compares the received operating temperature information OTI with the operating temperature basis value OTBV and generates an operating temperature comparison result. The operating temperature comparison result can indicate, for example, that the operating temperature information OTI is greater than the operating temperature basis value OTBV and that the operating temperature information OTI is less than or equal to the operating temperature basis value OTBV.

In some embodiments, the operating temperature basis value OTBV can be a default value (for example, 30° C.), or a user-defined parameter value. When the operating temperature basis value OTBV is set as 30° C., the processing module 220 can further more carefully confirm whether the system operating state is indeed in the overheat preventing state, thereby preventing the computer device 200 from too frequently performing the corresponding step (that is, restarting the computer device 200) to accordingly attend to both normal use for the user and the service life of the computer device 200. Additionally, determining the operating temperature basis value OTBV by a user-defined parameter value can enhance operation flexibilities for the user.

When the operating temperature comparison result indicates that the operating temperature information OTI is less than or equal to the operating temperature basis value OTBV, it is determined that the system operating state is in the normal state (that is, step S430B is performed subsequently). When the operating temperature comparison result indicates that the operating temperature information OTI is greater than the operating temperature basis value OTBV, it is determined that the system operating state is in the overheat preventing state (that is, step S430A is performed subsequently).

Thus, with the method shown in FIG. 4, the existing heat dissipation device operation information HDDOI and the existing operating temperature information OTI of the computer device 200 can be utilized appropriately to detect the system operating state, for the processing module 220 to timely, initiatively, and effectively perform the corresponding steps ahead of time. Additionally, the processing module 220 can further more carefully confirm whether the system operating state is indeed in the overheat preventing state, thereby preventing the computer device 200 from too frequently performing the corresponding step (that is, restarting the computer device 200) to accordingly attend to both normal use for the user and the service life of the computer device 200.

In some embodiments, only when the operation comparison result indicates that the heat dissipation device operation information HDDOI is less than the operation basis value OBV within the range of the predetermined time value, and the operating temperature comparison result indicates that the operating temperature information OTI is greater than the operating temperature basis value OTBV within the range of the predetermined time value, the processing module 220 then determines that the system operating state is in the overheat preventing state. In some embodiments, the predetermined time value can be a default value (for example, 10 minutes) or a user-defined parameter value. When the predetermined time value is set as 10 minutes, the processing module 220 can further more carefully confirm whether the system operating state is indeed in the overheat preventing state, thereby preventing the computer device 200 from too frequently performing the corresponding step (that is, restarting the computer device 200) to accordingly attend to both normal use for the user and the service life of the computer device 200. Additionally, determining the predetermined time value by a user-defined parameter value can enhance operation flexibilities for the user.

In some embodiments, the method for preventing overheating can be activated according to a user selection result. That is to say, a user can selectively uncheck a function block option corresponding to the method for preventing overheating in an operating interface of a basic input/output system (BIOS), such that processing module 220 does not perform the steps of the method for preventing overheating. Additionally, the user can again selectively check a function block option corresponding to the method for preventing overheating in an operating interface of a BIOS, for the processing module 220 to again perform the steps of the method for preventing overheating.

In some embodiments, since the BIOS itself is capable of receiving and displaying the heat dissipation device operation information HDDOI and the operating temperature information OTI of the computer device 200, a person of ordinary skill in the technical field pertinent to the present disclosure can use program languages such as C/C++ under the existing BIOS architecture to complete program design, thereby implementing the various steps of the method for preventing overheating described in the present disclosure.

In some embodiments, the various step in the method for preventing overheating described in the present disclosure can be further combined, replaced, repeated, and/or modified, so as to form new embodiments without going beyond the scope disclosed in the present disclosure.

In some embodiments, the various steps of the method for preventing overheating described in the present disclosure can be stored in a computer-readable recording medium, which can be, for example but not limited to, a non-transitory computer-readable recording medium such as a hard drive, an optical disk, a magnetic disk, a portable drive, or a network-accessible database. When a computer program product stored in the computer-readable recording medium is loaded and executed by a computer device, the computer device is enabled to perform any one of the methods for preventing overheating described in the present disclosure.

Although the present invention is described further in detail by way of specific embodiments above and the accompanying drawings, numerous modifications and changes may be made by a person skilled in the technical field pertinent to the present invention without departing from the scope or spirit defined in the appended claims. Therefore, the legal protection for the present invention shall be defined by the appended claims and shall not be restricted by the disclosure of the detailed description.

What is claimed is:

1. A method for preventing overheating, adapted to be performed by a computer device, the method for preventing overheating comprising:
detecting a system operating state;
restarting the computer device when the system operating state is in an overheat preventing state;
detecting the system operating state again after the computer device is restarted; and
restarting the computer device and adjusting an operating efficiency of the computer device to a low-efficiency mode when the system operating state is still in the overheat preventing state,
wherein the detecting of the system operating state comprises:
receiving heat dissipation device operation information;
comparing the heat dissipation device operation information with an operation basis value, and generating an operation comparison result; and
determining the system operating state according to the operation comparison result.

2. The method for preventing overheating according to claim 1, wherein the low-efficiency mode is an operation mode of setting the computer device to be operable with a highest operation efficiency without a heat dissipation device.

3. The method for preventing overheating according to claim 1, wherein the determining of the system operating state according to the operation comparison result comprises:
when the operation comparison result indicates that the heat dissipation device operation information is less than the operation basis value within a range of a predetermined time value, determining that the system operating state is in the overheat preventing state.

4. The method for preventing overheating according to claim 1, wherein the heat dissipation device operation information is a fan rotating speed value, and the operation basis value is 800 revolutions per minute (RPM).

5. The method for preventing overheating according to claim 1, wherein the detecting of the system operating state further comprises:
receiving operating temperature information of the computer device;
when the operation comparison result indicates that the heat dissipation device operation information is less than the operation basis value, comparing the operating temperature information with an operating temperature basis value, and generating an operating temperature comparison result; and
when the operation comparison result indicates that the heat dissipation device operation information is less than the operation basis value, the system operating state is further determined according to the operating temperature comparison result.

6. The method for preventing overheating according to claim 5, wherein the determining of the system operating state according to the operation comparison result comprises:
when the operation comparison result indicates that the heat dissipation device operation information is less than the operation basis value within a range of a predetermined time value, and the operating temperature comparison result indicates that the operating temperature information is greater than or equal to the operating temperature basis value within the range of the predetermined time value, determining that the system operating state is in the overheat preventing state.

7. The method for preventing overheating according to claim 1, wherein the method is activated according to a user selection result.

8. A system for preventing overheating, comprising:
a heat dissipation device, configured to provide heat dissipation device operation information; and
a computer device, configured to be coupled to the heat dissipation device;
wherein the computer device comprises:
a storage module, configured to have a computer program product stored therein; and
a processing module, configured to be coupled to the storage module;
wherein, after the processing module loads and executes the computer program product, the processing module is capable of performing a method for preventing overheating, the method for preventing overheating comprising:
detecting a system operating state;
restarting the computer device when the system operating state is in an overheat preventing state;
detecting the system operating state again after the computer device is restarted; and
restarting the computer device and adjusting an operating efficiency of the computer device to a low-efficiency mode when the system operating state is still in the overheat preventing state;
wherein, the detecting of the system operating comprises:
receiving the heat dissipation device operation information;
comparing the heat dissipation device operation information with an operation basis value, and generating an operation comparison result; and
determining the system operating state according to the operation comparison result.

9. The system for preventing overheating according to claim 8, wherein the low-efficiency mode is an operation mode of setting the computer device to be operable with a highest operation efficiency without the heat dissipation device.

10. The system for preventing overheating according to claim 8, wherein the determining of the system operating state according to the operation comparison result comprises:
when the operation comparison result indicates that the heat dissipation device operation information is less than the operation basis value within a range of a predetermined time value, determining that the system operating state is in the overheat preventing state.

11. The system for preventing overheating according to claim 8, wherein the heat dissipation device operation information is a fan rotating speed value, and the operation basis value is 800 revolutions per minute (RPM).

12. The system for preventing overheating according to claim 8, wherein the detecting of the system operating state further comprises:
receiving operating temperature information of the computer device;
when the operation comparison result indicates that the heat dissipation device operation information is less than the operation basis value, comparing the operating temperature information with an operating temperature basis value, and generating an operating temperature comparison result; and
when the operation comparison result indicates that the heat dissipation device operation information is less than the operation basis value, the system operating state is further determined according to the operating temperature comparison result.

13. The system for preventing overheating according to claim 12, wherein the determining of the system operating state according to the operation comparison result comprises:
when the operation comparison result indicates that the heat dissipation device operation information is less than the operation basis value within a range of a predetermined time value, and the operating temperature comparison result indicates that the operating temperature information is greater than or equal to the operating temperature basis value within the range of the predetermined time value, determining that the system operating state is in the overheat preventing state.

14. The system for preventing overheating according to claim 8, wherein the processing module is further capable of determining whether to activate the method for preventing overheating according to a user selection result.

15. A non-transitory computer-readable recording medium for preventing overheating, after a computer device loads and executes a computer program product stored in the non-transitory computer-readable recording medium, the computer device is capable of performing a method for preventing overheating, the method for preventing overheating comprising:
detecting a system operating state;
restarting the computer device when the system operating state is in an overheat preventing state;
detecting the system operating state again after the computer device is restarted; and
restarting the computer device and adjusting an operating efficiency of the computer device to a low-efficiency mode when the system operating state is still in the overheat preventing state;
wherein, the detecting of the system operating state comprises:
receiving heat dissipation device operation information;
comparing the heat dissipation device operation information with an operation basis value, and generating an operation comparison result; and
determining the system operating state according to the operation comparison result.

16. The non-transitory computer-readable recording medium for preventing overheating according to claim 15, wherein the determining of the system operating state according to the operation comparison result comprises:
when the operation comparison result indicates that the heat dissipation device operation information is less than the operation basis value within a range of a predetermined time value, determining that the system operating state is in the overheat preventing state.

17. The non-transitory computer-readable recording medium for preventing overheating according to claim 15, wherein the heat dissipation device operation information is a fan rotating speed value, and the operation basis value is 800 revolutions per minute (RPM).

18. The non-transitory computer-readable recording medium for preventing overheating according to claim 15, wherein the detecting of the system operating state further comprises:
receiving operating temperature information of the computer device;
when the operation comparison result indicates that the heat dissipation device operation information is less than the operation basis value, comparing the operating temperature information with an operating temperature basis value, and generating an operating temperature comparison result; and
when the operation comparison result indicates that the heat dissipation device operation information is less than the operation basis value, the system operating state is further determined according to the operating temperature comparison result.

19. The non-transitory computer-readable recording medium for preventing overheating according to claim 18, wherein the determining of the system operating state according to the operation comparison result comprises:
when the operation comparison result indicates that the heat dissipation device operation information is less than the operation basis value within a range of a predetermined time value, and the operating temperature comparison result indicates that the operating temperature information is greater than or equal to the operating temperature basis value within the range of the predetermined time value, determining that the system operating state is in the overheat preventing state.

20. The non-transitory computer-readable recording medium for preventing overheating according to claim 15, wherein the method for preventing overheating is activated according to a user selection result.
